(19) United States
(12) Patent Application Publication
(10) Pub. No.: US 2024/0352601 A1
(43) Pub. Date: Oct. 24, 2024

(54) ELECTROLYSIS CELL FOR POLYMER ELECTROLYTE MEMBRANE ELECTROLYSIS AND COATING

(71) Applicant: Siemens Energy Global GmbH & Co. KG, Erlangen (DE)

(72) Inventors: Andre Klinger, Nürnberg (DE); Yashar Musayev, Nürnberg (DE)

(21) Appl. No.: 18/685,245

(22) PCT Filed: Jun. 8, 2022
(86) PCT No.: PCT/EP2022/065575

§ 371 Date: Feb. 21, 2024

(30) Foreign Application Priority Data
Aug. 23, 2021 (EP) 21192595.3

(51) Int. Cl. C25B 11/069; C25B 9/23; C25B 11/032; C25B 11/036; C25B 13/08

(52) U.S. Cl. CPC C25B 11/069; C25B 9/23; C25B 11/032; C25B 11/036; C25B 13/08

(57) ABSTRACT

An electrolysis cell for polymer electrolyte membrane electrolysis with a cathodic half-cell and an anodic half-cell is provided. The cathodic half-cell and the anodic half-cell are separated from one another by a polymer electrolyte membrane. At least one of the half-cells has a channel structure which is formed by a gas diffusion layer and a bipolar plate. The bipolar plate has a main body made of a metal base material having a coating material. The coating material is present in a homogeneous mixed phase including titanium niobium (TiNb), titanium niobium nitride and also iridium and/or iridium carbide (IrC). A coating to be applied as a protective layer to a metal component of an electrolysis cell is also described. This coating comprises the constituents titanium niobium (TiNb) and titanium niobium nitride (TiNbN) and also admixtures of iridium carbide (IrC) and/or (Ir).

### BACKGROUND

The invention relates to an electrolysis cell for polymer electrolyte membrane electrolysis, to a coating for corrosion protection and to the use thereof.

Hydrogen can be obtained by electrolysis from deionized water. The electrochemical cell reactions that proceed are the hydrogen evolution reaction (HER) and oxygen evolution reaction (OER). In the case of acidic electrolysis, the reactions mentioned at the anode and cathode can be defined as follows:

Anode 2H₂O→4H⁺+O₂+4e⁻ (I)

Cathode H⁺+2e⁻→H₂ (II)

In what is called polymer electrolyte membrane electrolysis (PEM electrolysis), the two part-reactions according to equations (I) and (II) are conducted spatially separately in a respective half-cell for the OER and HER. The reaction spaces are separated by means of a proton-conductive membrane, the polymer electrolyte membrane (PEM), also known by the term proton exchange membrane. The PEM ensures substantial separation of the hydrogen and oxygen product gases, electrical insulation of the electrodes, and conduction of the hydrogen ions as positively charged particles. A PEM electrolysis system typically comprises a plurality of PEM electrolysis cells, as described in EP 3 489 394 A1, for example.

A PEM electrolysis cell is described, for example, in EP 2 957 659 A1. The PEM electrolysis cell shown there comprises an electrolyte formed of a proton-conductive membrane (proton exchange membrane, PEM), on either side of which are located the electrodes, a cathode and an anode. The unit made up of membrane and electrodes is referred to as the membrane electrode assembly (MEA). A gas diffusion layer lies against each electrode. The gas diffusion layers are contacted by what are known as bipolar plates. A respective bipolar plate forms a channel structure configured for media transport of the reactant and product streams involved. At the same time, the bipolar plates separate the individual electrolysis cells from one another, the latter being stacked to form an electrolysis stack having a multiplicity of electrolysis cells. The PEM electrolysis cell is fed with water as reactant which at the anode is electrochemically decomposed into oxygen product gas and protons H⁺. The protons H⁺ migrate through the electrolyte membrane in the direction of the cathode. They recombine on the cathode side to form hydrogen product gas H₂.

These cell reactions according to equations (I) and (II) are in equilibrium with their reverse reactions at a cell voltage of 1.48 V, taking account of the increase in entropy on transformation of the liquid water to gaseous hydrogen and oxygen. In order to achieve correspondingly high flows of product in an appropriate time (production output) and hence a flow of current, there is a need for a higher voltage, the overvoltage. PEM electrolysis is therefore conducted at a cell voltage of about 1.8-2.1 V.

A PEM electrolysis cell is also described in Kumar, S. et al., Hydrogen production by PEM water electrolysis—A review, Materials Science for Energy Technologies, 2 (3) 2019, 442-454. https://doi.org/10.1016/j.mset.2019.03.002. The PEM electrolysis cell consists, considered from the outside inward, of two bipolar plates, gas diffusion layers, catalyst layers and the proton-conductive membrane.

High oxidative potentials arise at the anode because of the evolution reaction of oxygen, and therefore high-value materials having fast passivation kinetics, for example titanium, are generally used, especially for the gas diffusion layer. However, high demands are also placed on the material choice for the anode-side catalyst material and also on the bipolar plate which lies against the gas diffusion layer and electrically contacts same. This results in the formation of a respective channel structure for the media transport of the reactant and product streams involved. However, due to the high oxygen content at the anode, even these measures cannot wholly prevent the degradation effects and corrosion at the anode, but at best delay them.

In contrast, the potential is less oxidative at the cathode, and so it is possible, for example, to manufacture the gas diffusion layers there from stainless steel. However, these corrode as a result of the acidic medium of the PEM electrolysis inter alia. This corrosion process is called acid corrosion. It is not necessary here for elemental oxygen to be present, since this is already provided alone by the dissociation of the surrounding water. The metal ions at the interface of the metal surface are oxidized by the hydroxide anion to the respective hydroxide salt. This leads to degradation of the cell, which is manifested by an increase in internal resistance and by extrinsic introduction of ions into the PEM.

The prior art describes various approaches for combating the above-elucidated degradation effects at the anode and at the cathode. For example, for the anode-side catalyst it has been proposed in the catalyst layer to introduce a relatively large amount of catalytically active species into the anodic catalyst layer, i.e. to provide for a relatively high concentration of catalytically active species. This makes it possible in particular to at least temporarily compensate degradation effects of the anode with respect to the catalytic activity. In order to reduce anode-side degradation effects as a result of local electrical contact resistances and an accompanying inhomogeneous current distribution in the gas diffusion layer and catalyst layer composite system, it has been proposed inter alia to optimize the contact pressure of the gas diffusion layer against the catalyst layer. However, this always harbors the risk of perforation of the membrane electrode assembly (MEA) through an excessively high contact pressure during the joining together and axial stacking of the electrolysis cells to form an electrolysis stack and the mechanical bracing thereof with a high axial force. This leads to short circuits, as a result of which the electrolysis cell is unusable and operation of the electrolyzer is considerably jeopardized or even ruled out.

DE 10 2017 118 320 A1 discloses a process for producing components, in particular components for energy systems such as fuel cells or electrolyzers. This document discloses a current-withdrawing metallic bipolar plate of which the base body—a metal sheet—is coated with a three-coat layer system, with a first undercoat layer being applied to the metal sheet. A second undercoat layer is applied to the first undercoat layer and a top layer is lastly applied as third layer to the second undercoat layer. The first undercoat layer is in the form of a metallic alloy layer, comprising the metals titanium and niobium with a layer thickness of 0.1 μm. The second undercoat layer having a layer thickness of 0.4 μm includes the alloying metals titanium, niobium and also nitrogen. A top layer of iridium carbide (IrC) having a 10 to 20 nm layer thickness is applied to the second undercoat layer. Therefore, in the multi-coat layer system of DE 10 2017 118 320 A1, a layer thickness of more than 0.5 μm should be set in order to achieve corrosion protection for a bipolar plate.

Hardly any measures have to date been proposed with respect to improving the corrosion protection in connection, for example, with the channel structure, which spatially delimits an electrolysis cell and at the same time ensures contacting and mass transport. Especially on the anode side, there is a considerable need for improvement in corrosion protection for the further metallic components of the electrolysis cell as well, for example the gas diffusion layer.

The abovementioned approaches therefore do not sufficiently sustainably or reliably solve the actual problems of degradation caused by corrosion, in particular at the anode, for operation of the electrolysis cell. They are at best temporary measures for partly lessening the degradation effects and temporally spreading them out for longer operation, but fail to tackle the cause.

### SUMMARY

Embodiments include an electrolysis cell for polymer electrolyte membrane electrolysis including a cathodic half-cell and an anodic half-cell, wherein the cathodic half-cell and the anodic half-cell are separated from one another by means of a polymer electrolyte membrane, at least one of the half-cells having a channel structure formed of a gas diffusion layer and of a bipolar plate, wherein the bipolar plate has a base body made of a metallic base material and to which a coating of a coating material has been applied, and wherein the coating material is present in a homogeneous mixed phase comprising titanium-niobium (TiNb), titanium niobium nitride and also iridium and/or iridium carbide (IrC).

Embodiments also include a method for applying coating application as protective layer to a metallic component of an electrolysis cell, the coating comprising titanium-niobium (TiNb) and titanium niobium nitride (TiNbN) and alternatively either iridium carbide (IrC) or iridium (Ir), or iridium carbide (IrC) and iridium as a blend.

### DETAILED DESCRIPTION

Against this background, an object of the invention is that of making available an electrolysis cell with which the abovementioned corrosion problems can be reduced or preferably avoided completely. A further object of the invention is that of specifying a coating for corrosion protection that satisfies these particular demands in operation of an electrolysis cell.

This object is achieved, according to the invention, by the subjects of the independent claims. The dependent claims relate to preferred configurations of the solutions according to the invention.

A first aspect of the invention relates to an electrolysis cell for polymer electrolyte membrane electrolysis, having a cathodic half-cell and an anodic half-cell, wherein the cathodic half-cell and the anodic half-cell are separated from one another by means of a polymer electrolyte membrane. At least one of the half-cells has a channel structure formed of a gas diffusion layer and of a bipolar plate, wherein the bipolar plate has a base body made of a metallic base material and to which a coating of a coating material has been applied, wherein the coating material is present in a homogeneous mixed phase comprising titanium-niobium (TiNb), titanium niobium nitride and also iridium and/or iridium carbide (IrC).

The anodic half-cell and the cathodic half-cell thus alternatively have a respective channel structure, comprising a base body made of a metallic base material, with an advantageously thin mixed crystal coating having been applied to the base body of the bipolar plate. This homogeneous mixed phase of binary and ternary titanium compound with an admixture of iridium black or iridium carbide leads to a marked increase in corrosion protection in bipolar plates of electrolysis cells and electrolyzers. At the same time, the homogeneous mixture entails a reduction in the material use of expensive iridium compounds, and therefore correspondingly thinner layer thicknesses and simpler constructions are possible compared to known multilayer systems. A closed, corrosion-stable coating can be provided as a result.

Reference is made to the introductory explanations for the terms electrolysis and polymer electrolyte membrane and also the reactions and (corrosion) processes taking place. The polymer electrolyte membrane can for example be formed from a tetrafluoroethylene-based polymer having sulfonated side groups. The cathodic half-cell forms the reaction space in which the cathode reaction(s), for example according to equation (II), proceed. The anodic half-cell forms the reaction space in which the anode reaction(s), for example according to equation (I), proceed.

The invention proceeds from the finding that only inadequate solution approaches that fail to address the cause have been proposed to date for avoiding or reducing technical problems and limitations due to corrosion-related degradation effects in an electrolysis cell, in particular on the side of the anodic half-cell. For example, in water electrolysis in an electrolysis cell, in particular metallic components and elements of the anode, i.e. components and elements on the oxygen side, are exposed to oxidative attacks to a great degree, which threatens long-term reliable and efficient operation. While high-value metallic materials, such as for example titanium and stainless steels of the category 1.4404 or 1.4571, are used in the anode space of the electrolysis cell because of the high oxygen content, these materials also form oxides as a result of the massive exposure to oxygen. Corrosion stability is not sufficiently provided.

These oxidative wear/degradation phenomena lead to material removal and moreover to a disadvantageous increase in the contact and transfer resistances in the electrolysis cell. On the anode side this affects the gas diffusion layer and the bipolar plate to a particular degree, the latter forming not just the electrical contacting but at the same time also a channel structure for media transport of reactant stream and product stream. The result of this is firstly deterioration in the cell voltage and secondly the problem resulting from the limited corrosion stability of the stainless steel used that an entry of metal cations, for instance Fe³⁺ or Fe²⁺ cations, into the polymer electrolyte membrane occurs, followed by harmful reactions. This likewise leads to a deterioration in cell voltage resulting from a reduced ionic conductivity of the membrane.

The observation of the increase in the local electrical contact resistance has an essential cause in a rapidly manifesting oxidation (passivation) of the material during operation of the gas diffusion layer. The oxidation can predominantly be observed at the surface of the gas diffusion layer and adjoining current-carrying electrical contact surfaces. These local contact surfaces that are then electrically poorly conducting due to the oxidation lead to high ohmic losses in the electrolysis cell and to a necessary increase in the cell voltage at constant current density. Efficiency losses and degradation of the anode are the result here of inhomogeneous current distribution with disadvantageous local current peaks.

These disadvantageous effects are largely avoided or even overcome with the invention.

The invention advantageously counters the problems described by the channel structure of the anodic half-cell or of the cathodic half-cell having a corrosion-resistant coating. The corrosion-resistant coating of the channel structure has been applied to the metallic base material as protective coating. The channel structure has a base body of suitable geometry made of a metallic base material, for example titanium or stainless steel, to which the corrosion-resistant coating has been applied. The corrosion-resistant coating itself is electrically conductive so that an electrical contacting with simultaneous mass transport for reactants and products in the anodic half-cell is additionally guaranteed.

This configuration provided by the invention can first counteract the various corrosion phenomena in the channel structure at the cause, so that the anodic half-cell withstands the oxidative environment during the water electrolysis for longer. In the coating concept the corrosion-resistant coating has preferably been applied to the channel structure either as a full-area closed and corrosion-stable protective layer or adapted to the local environment with at least a coating in regions of the surface of the metallic base body at the points that are particularly at risk of oxidation.

Depending on the configuration of the anodic half-cell, the channel structure can functionally also include the adjoining gas diffusion layer or functional parts of the gas diffusion layer which in any case also enable media transport in the half-cell and for this purpose delimit the channel wall of the channel structure. The corrosion-resistant coating can thus have been applied as required and flexibly to the surface of a plurality of functionally interacting components that form the channel structure in the anodic half-cell. Thus, in addition to the bipolar plate itself, further components which are important for a functional formation of a channel structure of the anodic half-cell made of a metallic base material, such as for example nonwovens, expanded metals and gas diffusion plies, can also have the corrosion-resistant coating. The term “channel structure” is therefore to be interpreted comprehensively and functionally for the invention. In particular, the channel structure therefore includes not just the configuration or implementation in the form of a bipolar plate made of a metallic base body but also, depending on the construction of the electrolysis cell, further components having a base body made of a metallic base material and forming the channel structure. The channel structure can therefore generally be formed by the interaction of a plurality of components, for example by an interaction of the bipolar plate and an immediately adjacently arranged gas diffusion layer, so that a fluid channel is formed for the transport of the reactant and product streams.

In one embodiment of the electrolysis cell, the coating has been applied as a homogeneous single-coat layer on the base body.

The coating preferably includes titanium-niobium (TiNb) and titanium niobium nitride (TiNbN) as base constituents, to which iridium (Ir) and/or iridium carbide (IrC) has been admixed. In the homogeneous mixed phase or in the mixed crystal the admixing of for example 5% by weight-25% by weight, preferably 8% by weight to 15% by weight of iridium black or iridium carbide makes it possible to reduce the material use of expensive iridium while achieving the desired anticorrosion action. Low layer thicknesses are possible with good adhesion properties of the mixed crystal on the base body.

In one embodiment, the corrosion-resistant coating includes a coating material having a high oxidation potential.

Noble metals and noble metal alloys generally have a high oxidation potential and are largely resistant to oxygen corrosion. These coating materials can withstand the environment of the high oxygen concentration in the channel structure of the anodic half-cell and are suitable in principle for the corrosion-resistant protective layer. Preference can be given here to a closed corrosion-resistant or corrosion-preventing protective layer on the metallic base body in order to shield from the anodic oxidation concentration and corresponding oxidative attacks on the metallic base material.

For a first choice of coating material for the corrosion-resistant coating of the channel structure, the redox potential can serve as a measure for the readiness of the ions to accept electrons. The ions of the noble metals more readily accept electrons than the ions of non-noble metals, for which reason the redox potential of the Cu/Cu²⁺ pair, at +0.35 V, is much more positive than that of the Zn/Zn²⁺ pair, at −0.76 V, under standard conditions. This in turn means that Zn belongs to the less-noble metals and is a stronger reducing agent, that is to say reduces its reaction partner and is itself oxidized and donates electrons. This is adaptable under cost/benefit considerations, process regime for the coating process and achievable quality of the corrosion-resistant coating.

In one embodiment, the corrosion-resistant coating includes iridium and/or iridium carbide as constituent. Alternatively iridium or iridium carbide or, alternatively, both iridium and iridium carbide together can be present in the coating material as constituents in the coating material. It has been found that iridium or iridium carbide in particular are especially suitable as corrosion protection in an electrolysis cell. Further constituents in the coating material are not ruled out here, and thus the material requirement for expensive iridium can be limited to a small amount in the corrosion-resistant coating which is functionally necessary for an anticorrosion effect that is to be achieved. The proportion required for the effect can be adjusted accordingly depending on the requirement. There is thus generally provision for not only iridium and/or iridium carbide but also further constituents to be present in the corrosion-resistant coating.

The corrosion-resistant coating includes as constituent a binary and/or ternary compound containing titanium. A mixture of binary and ternary titanium compound can also flexibly be used. There is thus preferably provision for the corrosion-resistant coating to contain a mixture of binary and ternary titanium compound and also proportions of iridium and/or iridium carbide as admixture. The coating system can then for example be present in a mixed phase or as a mixed crystal with the corresponding number of constituents, this being particularly advantageous. A mixed phase in thermodynamics is understood to be a homogeneous phase consisting of two or more substances. Solid mixed phases are also referred to as solid solutions or mixed crystals. The proportions of the individual components of a mixed phase can be reported as partial quantities with the aid of the molar proportion x. The molar proportion is advantageously adjustable via the thickness of the corrosion-resistant coating in order to adapt the anticorrosion effect and to optimize the material use.

Preferably, the binary compound includes titanium-niobium (TiNb) and the ternary compound titanium niobium nitride (TiNbN). It has surprisingly been found that this titanium-niobium-based material class under the given requirements for the coating of the channel structure proves to be particularly effective for corrosion protection in conjunction with iridium and/or iridium carbide. A coating system is thus advantageously provided for corrosion protection that permits various adaptations and, with respect to molar proportions and the number of layers, various configurations, and applications in the coating of components and surface regions of the electrolysis cell that are at particular risk of oxidation, such as for instance for the bipolar plate, the gas diffusion layer, for nonwovens and for gas diffusion plies and generally the channel structure configured for mass transport and electrical contacting.

Preferably, at least in the region of the channel structure the coating has been applied to the bipolar plate over the whole area in the form of a closed protective layer on the base body thereof.

The base body of the bipolar plate preferably has a multiplicity of grooves or channels, such that during operation of the electrolysis cell fluid transport is promoted in the channel structure and a uniform electrical contacting and voltage supply of the half-cells can be brought about.

In one embodiment, the corrosion-resistant coating has a layer thickness of around 0.02 to 0.5 micrometers, in particular of around 0.08 to 0.3 micrometers. The layer thickness and layer composition are selectable and adjustable depending on the component to be coated for corrosion protection. The components and regions having metallic base material that are at risk of corrosion can thus be provided with the coating in the electrolysis cell. A plurality of components may have the corrosion-resistant coating with a respective layer thickness, in particular the components that form the channel structure of the anodic half-cell, such as bipolar plates, gas diffusion plies, nonwovens and expanded metals. Depending on the component, the layer thickness range is preferably 0.02-0.5 micrometers and can in each case be adjusted through the chosen coating process.

In a further embodiment, the corrosion-resistant coating is implemented as single-coat, multicoat or graded layers.

The corrosion-resistant coating can consequently in the simplest case have been applied as a homogeneous single-coat layer to the substrate, that is to say for example the metallic base material of the channel structure. In this case the chosen layer constituents in the system titanium-niobium, titanium niobium nitride are particularly preferably present with the iridium and optional further additions in a homogeneous mixed phase or as mixed crystal. However, it is also possible for the corrosion-resistant coating to be implemented as a graded multi-coat layer, as a graded single-coat layer having a continuous gradient in the chemical layer composition or as graded multi-coat layers having a continuous gradient in the chemical layer composition. A configuration as a nanostructured layer system is also conceivable for the corrosion-resistant coating.

Coating processes such as physical vapor deposition (PVD) or plasma-assisted chemical vapor deposition (PACVD) or generally coating methods of physical thin-film technology are preferably used to apply the corrosion-resistant coating to the metallic base material of the component.

In the PVD (physical vapor deposition) process, an ionized metal vapor is generated that reacts with various gases in the plasma and deposits a thin film on workpiece surfaces. The most widespread PVD methods today are arc deposition and sputtering. Both methods are performed under high vacuum conditions in a coating chamber.

In contrast to chemical vapor deposition processes, physical processes are used to convert the starting material into the gas phase. The gaseous material is then conveyed to the substrate to be coated where it condenses and forms the targeted layer.

Plasma-enhanced chemical vapor deposition PECVD, also known as plasma-assisted chemical vapor deposition PACVD, is a special form of chemical vapor deposition (CVD) in which the chemical deposition is assisted by a plasma. The plasma can burn directly at the substrate to be coated (direct plasma method) or in a separate chamber (remote plasma method).

The use of these processes makes it possible to apply complex coatings of varying composition with a high quality. For example, for applying a TiNbN coating by means of plasma technology, as a result of the energy input from an arc into the target, titanium/niobium atoms are released, ionized and as a result of the applied voltage accelerated in the direction of the substrate, i.e. the base body, of the metallic base material. The titanium/niobium atoms then bond with the nitrogen atoms introduced to form the desired TiNbN layer. The input of further constituents into the coating or layer is effected correspondingly.

In one embodiment, the base material is stainless steel or titanium. This is a particularly advantageous choice of material for gas diffusion layers, nonwovens, bipolar plates and further components of the electrolysis cell, in particular for the anodic half-cell. For example, titanium can be chosen for the gas diffusion layer and stainless steel for the bipolar plate. In this way the channel structure formed on the anodic half-cell is on the one hand electrically conductive and on the other equipped with effective corrosion protection for the mass transport in the electrolysis. The choice of material for the substrate and coating material additionally makes it possible to achieve good process control in the respectively chosen coating process and also good layer adhesion of the corrosion-resistant coating and hence a good layer quality, which increases the service life due to the high adhesion strength of the titanium-based coating.

Achievable in particular is a desired layer surface having low surface roughness of for example an arithmetic mean roughness value of Rₐ<0.05 micrometers, which is greatly advantageous for a good and above all areally uniform electrical contacting in an electrolysis cell. In addition, a high adhesion strength of the corrosion-resistant coating and mechanical wear resistance are achievable.

In the context of the present invention, a layer or coating can be understood to be a planar structure the dimensions of which in the layer plane, the length and width, are much larger than the dimension in the third dimension, the layer thickness.

The introduction of material into layers, for example a corrosion-resistant coating material or other materials, makes it possible in a particularly simple manner to realize a predefinable distribution of the materials in the anodic half-cell. In addition, the handling of the materials can be made easier.

It is thus preferably possible for the gas diffusion layer, which is formed of a base body made of a base material, to which a corrosion-resistant coating has been applied over the area. In this sense, in the gas diffusion layer, the base body with the base material forms a first layer and the corrosion-resistant coating forms a second layer of the gas diffusion layer. The second layer can in turn be a layer system having a plurality of coats. A corresponding situation applies for the other components of the electrolysis cell, such as for instance the bipolar plate or all further components that form a channel structure, to which a corrosion-resistant coating has been applied.

A further aspect of the invention relates to the use of an electrolysis cell for the electrolytic production of hydrogen.

In this way, advantageously, the reactions according to equations (I) and (II) can be carried out in the cathodic and anodic half-cells when an electric current flows through the electrolysis cell.

A further aspect of the invention relates to a corrosion-resistant coating for application as protective layer to a metallic component of an electrolysis cell, including the constituents titanium-niobium and titanium niobium nitride (TiNbN) and also iridium carbide and/or iridium.

Particular preference is given here to the use in a bipolar plate that forms a channel structure and/or in a gas diffusion layer as metallic component of an electrolysis cell, in particular in an anodic half-cell (7) of an electrolysis cell (1).

By means of the corrosion-resistant coating according to the invention, one of the above-described electrolysis cells for polymer electrolyte membrane electrolysis can be coated or the corrosion-resistant coating is applied to components in an electrolysis cell that are at particular risk of corrosion, to their base body made of a metallic base material. The corrosion-resistant coating is therefore preferably used in the anodic half-cell in order to counteract the oxygen-induced corrosion dominating there. Concerning the corrosion-resistant coating, reference is accordingly made to the explanations above and the advantages of these electrolysis cells.

The invention provides that the corrosion-resistant coating includes as base constituents titanium-niobium and titanium niobium nitride and an admixture of iridium and/or iridium carbide. The admixture means that the material use of expensive iridium is limited or markedly reduced compared to a monocoat of an iridium-based protective layer, without adversely affecting the corrosion protection.

In one embodiment, the corrosion-resistant coating is implemented as a homogeneous single-coat layer, graded single-coat layer or graded multi-coat layer.

The corrosion-resistant coating can in one embodiment be configured as a homogeneous single-coat layer. In this case for example the chosen layer constituents in the system titanium-niobium, titanium niobium nitride are present with the iridium and optional further additions in a homogeneous mixed phase that preferably forms a closed corrosion-stable protective layer or a coat on the base body. This is a particularly cost-effective configuration of the corrosion protection in the oxidative environment of use.

However, it is also possible for the corrosion-resistant coating to be implemented as a graded single-coat layer having a continuous gradient in the chemical layer composition or as graded multi-coat layers having a continuous gradient in the chemical layer composition. A configuration as a nanostructured layer system is also conceivable for the corrosion-resistant coating.

In an alternative configuration, the corrosion-resistant coating can preferably be implemented as a multi-coat layer with iridium carbide and/or iridium as layer constituent in the top layer.

This advantageously also means that it is possible to achieve a saving on material for the use of expensive iridium and iridium carbide. It essentially suffices to provide iridium and/or iridium oxide as constituents in sufficient concentration in the top layer directly exposed to the oxidative medium in a multi-coat layer. These are preferably the essential constituents of the top layer, although it is possible that the top layer alternatively includes iridium or iridium oxide as main constituent. In a multi-coat layer, then, further coats are provided below the top layer which include further materials such as titanium-niobium and titanium niobium nitride, optionally with proportions of iridium and/or iridium oxide as admixture or in an appropriately selected concentration gradient decreasing preferably in the direction of the substrate or base body. This optionally results in the formation of corresponding graded multicoat mixed phases in the corrosion-resistant coating.

In one embodiment, iridium and/or iridium carbide are used as constituent of a corrosion-resistant coating of a metallic component of an electrolysis cell.

In one embodiment, as further constituent of the corrosion-resistant coating, titanium-niobium and/or titanium niobium nitride are used.

One use of the corrosion-resistant coating is provided in a channel structure or in a gas diffusion layer that are used as metallic components in an electrolysis cell, in particular in an anodic half-cell. The channel structure is preferably formed by the immediately adjacent arrangement of a bipolar plate with the fluid-permeable gas diffusion layer. Both the bipolar plate and the gas diffusion layer form metallic components or elements of the electrolysis cell on account of the required electrical conductivity and at the same time form the flow channel for the transport of the fluids, i.e. reactant stream and product stream are conducted through the channel structure. Advantageously, therefore, the surfaces of the channel structure that delimit the channel structure, which during operation are exposed to the oxygen and corrosion attacks, are provided with the corrosion-resistant coating.

The gas diffusion layer of the anodic half-cell has a porous material to ensure sufficient gas permeability. The gas diffusion layer can for example be manufactured from titanium as base material with a porous base body, for instance a titanium-based expanded metal or wire mesh, and coated with the corrosion-resistant coating. This can increase the useful life or lifetime of the gas diffusion layer, the described disadvantageous oxidation-related degradation effects being reduced. It is therefore advantageous to apply the corrosion-resistant coating according to the invention to the metallic base body of the gas diffusion layer as a protective layer. The corrosion-resistant coating can be used as corrosion protection on further components of the anodic half-cell having a metallic base body, in particular titanium or stainless steel.

The coating concept of the invention moreover results in the local electrical contacts being considerably improved and hence the current density over the cell area becoming more homogeneous. Besides the corrosion protection, this results in a better and above all more uniform current distribution during operation of the electrolysis cell.

In one embodiment, the anodic half-cell has a gas diffusion layer formed from titanium as base material. Preference is given here to using a configuration as fine-mesh titanium material as base material for the gas diffusion layer, for example titanium nonwovens, titanium foams, titanium weave, titanium-based expanded grids or combinations thereof. As a result of this, the local points of contact with the electrode are also increased and the electrical resistance in the contact area becomes particularly uniform. The term “grid” in the present context denotes a fine-mesh lattice. The support materials mentioned feature a high corrosion resistance. The terms “grid” and “weave” describe an oriented structure, the term “nonwoven” an unoriented structure.

A channel structure can preferably be arranged adjacent to, in particular directly adjacent to, the gas diffusion layer, or a channel structure is functionally formed by the adjacent arrangement of gas diffusion layer and a component, in particular a bipolar plate. The channel structure serves to collect and discharge the gaseous reaction product of the electrolysis in the anodic half-cell, thus for example oxygen according to equation (I). The channel structure can for example comprise or be in the form of a bipolar plate. Bipolar plates enable the stacking of multiple electrolysis cells to form an electrolysis cell module, in that they electrically conductively connect the anode of one electrolysis cell with the cathode of an adjacent electrolysis cell. In addition, the bipolar plate enables gas separation between adjoining electrolysis cells.

### BRIEF DESCRIPTION OF THE FIGURES

The invention is elucidated on the basis of preferred embodiments hereinafter by way of example and with reference to the appended figures, where the features presented hereinafter can constitute an aspect of the invention both taken alone and in various combinations with one another. In the figures:

FIG. 1 shows a schematic illustration of an electrolysis cell for polymer electrolyte membrane electrolysis according to the prior art;

FIG. 2 shows an exemplary anodic half-cell with channel structure and corrosion-resistant coating according to the invention;

FIG. 3 shows a corrosion-resistant coating in a configuration as homogeneous single-coat layer;

FIG. 4 shows a corrosion-resistant coating in a configuration as graded single-coat layer;

FIG. 5 shows a corrosion-resistant coating in a configuration as multi-coat layer;

FIG. 6 shows a corrosion-resistant coating in a configuration as graded multi-coat layer.

### DETAILED DESCRIPTION OF THE FIGURES

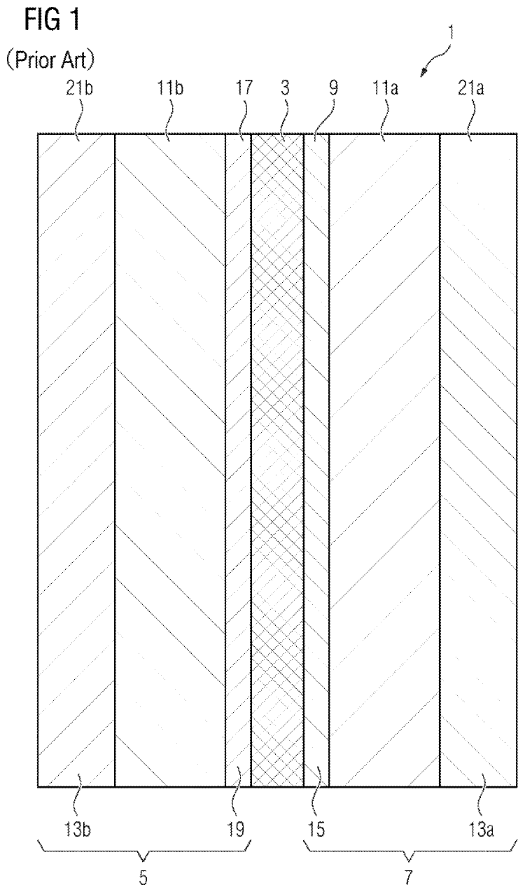

FIG. 1 shows an electrolysis cell 1 for polymer electrolyte membrane electrolysis according to the prior art in a schematic illustration. The electrolysis cell 1 serves for the electrolytic generation of hydrogen.

The electrolysis cell 1 has a polymer electrolyte membrane 3. Arranged on one side of the polymer electrolyte membrane 3, on the left in the illustration according to FIG. 1, is the cathodic half-cell 5 of the electrolysis cell 1, and arranged on the other side of the polymer electrolyte membrane 3, on the right in the illustration according to FIG. 1, is the anodic half-cell 7 of the electrolysis cell 1.

The anodic half-cell 7 comprises an anodic catalyst layer 9 arranged directly adjacent to the polymer electrolyte membrane 3, a gas diffusion layer 11a arranged directly adjacent to the anodic catalyst layer 9 and a bipolar plate 21a arranged directly adjacent to the gas diffusion layer 11a such that a channel structure 13a for fluid transport is formed. The anodic catalyst layer 9 comprises an anodic catalyst material 15 and catalyzes the anode reaction according to equation (I). Chosen as the anodic catalyst material 15 is iridium or iridium oxide as catalytically active species, which has been introduced into the anodic catalyst layer 9. Iridium or iridium oxide has a high oxidation and solution stability and is therefore well suited as anodic catalyst material 9. In order to reduce corrosion, the gas diffusion layer 11a is produced from a material on the surface of which a passivation layer rapidly forms, for example from titanium. The passivation of the titanium results in the formation of titanium dioxide, which however has a lower electrical conductivity than titanium. The channel structure 13a is in the form of the bipolar plate 21a, so that stacking of multiple electrolysis cells 1 is made possible.

The cathodic half-cell 5 comprises a cathodic catalyst layer 17 having a cathodic catalyst material 19, which is arranged directly adjacent to the polymer electrolyte membrane 3. The cathodic catalyst material 19 is formed for the catalysis of a reduction of hydrogen ions (protons), in particular according to equation (II), to give molecular hydrogen. A gas diffusion layer 11b is also arranged on the cathodic catalyst layer 19. In contrast to the gas diffusion layer 11a of the anodic half-cell 7, the gas diffusion layer 11b of the cathodic half-cell 5 is manufactured from stainless steel. This is possible on account of the lower oxidation potential in the cathodic half-cell 5 compared to the anodic half-cell 7, and reduces the costs of the electrolysis cell 1. Likewise arranged immediately adjacent to the gas diffusion layer 11b is a channel structure 13b which, analogously to the anodic half-cell 7, is in the form of a bipolar plate 21b. In cooperation with the respective immediately adjacently arranged bipolar plate 21a, 21b, the gas diffusion layers 11a, 11b functionally form a respective channel structure 13a, 13b, that is to say a fluid-tight flow channel for the mass transport of the reactants and the products in the electrolysis.

A disadvantage with this electrolysis cell 1 known from the prior art is, as elucidated at the outset, generally the corrosion susceptibility of the materials. Especially in the anodic half-cell 7, considerable degradation effects can be observed that highly disadvantageously impair the service life of the electrolysis cell 1.

Firstly, a harmful corrosion of the materials used can be observed here during operation on account of the high oxygen concentration in the anode-side half-cell 7 and the high oxidative potential. This especially affects the stainless steels of material number 1.4404 or 1.4571, for example, which are used as material for the bipolar plate 21a that forms the channel structure 13a. However, the more resistant titanium is also subjected to oxidative attacks. As a result, an increase in the local electrical contact resistance can be observed during operation. This has an essential cause in a rapidly manifesting oxidation (passivation) of the titanium during operation of the gas diffusion layer 11a. The oxidation can predominantly be observed at the surface of the gas diffusion layer 11a and adjoining current-carrying electrical contact surfaces. These local contact surfaces that are then electrically poorly conducting due to the oxidation lead to high ohmic losses in the electrolysis cell 1 and to a then-necessary increase in the cell voltage at constant current density. Efficiency losses and degradation of the anodic half-cell 7 are the result here of inhomogeneous current distribution with disadvantageous local current peaks.

Certain disadvantageous effects can also be observed on the side of the cathodic half-cell 5, especially with respect to the acid corrosion promoted by elemental oxygen, but this is not discussed in more detail in the present case here.

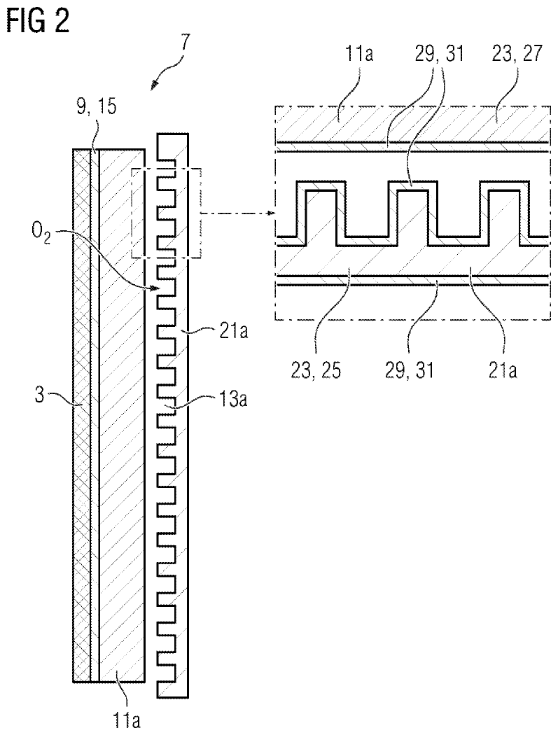

To overcome the disadvantages at the anodic half-cell 7, it is proposed in the anodic half-cell 7 to provide the channel structure 13a with a corrosion-resistant coating 29 such that the disadvantageous and, during operation, continuous oxidative attack is inhibited or in the best case even largely suppressed. Such an advantageously modified and further developed electrolysis cell 1 is shown by way of example schematically in FIG. 2, but with greater detail of the essential components with respect to FIG. 1. The anodic half-cell 7 of the exemplary embodiment of an electrolysis cell 1 shown in FIG. 2 is composed similarly to the electrolysis cell 1 according to FIG. 1 in terms of the basic structure, meaning that reference can be made to the statements made in this respect.

The anodic half-cell 7, likewise by analogy to the electrolysis cell according to FIG. 1, has a gas diffusion layer 11a and a bipolar plate 21a. The gas diffusion layer 11a has a base body 23 made of a metallic base material 27 that in the present case is titanium. The gas diffusion layer 11a here is implemented as a titanium-based expanded grid so as to enable fluid transport. Similarly, the bipolar plate 21a has a base body 23 made of a metallic base material 25 that in the present case is stainless steel. A multiplicity of grooves or channels have been milled into the base body 23 of the bipolar plate 21a in order to promote fluid transport and at the same time uniform electrical contacting and voltage supply of the anodic half-cell 7.

The gas diffusion layer 11a and the bipolar plate 21a have been configured and arranged adjacent to one another here such that a channel structure 13a has been formed comprising the metallic base body 23 made of the metallic base material 25, 27. In contrast to the electrolysis cell 1 according to FIG. 1, the channel structure 13a of the anodic half-cell 7 has been configured for effective corrosion protection. To this end, the channel structure 13a has a corrosion-resistant coating 29 made of a coating material 31. The coating material 31 has been chosen such that it has a high oxidation potential and at the same time is electrically conductive. The coating material 31 to this end includes a binary and a ternary titanium compound, in the present case titanium-niobium (TiNb) and titanium niobium nitride in a homogeneous mixed phase, where iridium and/or iridium carbide as further constituents have been admixed with the mixed phase in a flexibly adjustable amount.

As a result of this, the requirement for iridium needed can be limited to a minimum or markedly reduced with respect to an iridium layer or iridium carbide layer. At the same time, the interaction of the binary and ternary titanium constituents in the coating material 31 achieves an effective and long-term stable corrosion protection and promotes good layer adhesion to the metallic base material 25, 27. In the exemplary embodiment, the corrosion-resistant coating 29 has been applied to the bipolar plate 21a over the whole area in the form of a closed protective layer on the base body 23, at any rate as shown in the region of surfaces that delimit the channel structure 13a. However, the coating measure can alternatively also be locally restricted to the surface regions of the bipolar plate 21a that are particularly critical with respect to oxidation. The gas diffusion layer 11a is likewise provided with the corrosion-resistant coating 31 over the whole area at least with its side facing the bipolar plate 21a, meaning that a closed and effective corrosion protection has been applied to the channel structure 13a overall. It is a great advantage that essentially the same coating material 31 in terms of the constituents is usable for the corrosion-resistant coating 31 for the gas diffusion layer 11a and also for the bipolar plate 21a. However, it is also possible and reasonable to make adjustments in terms of the specific composition, for instance to the concentration of the respective constituent of the coating material 31 in the mixed phase. In addition, adaptations may be made in view of the specific layer structure of the corrosion-resistant coating 29 taking into account the respective component, the geometry thereof and the oxidative environment, in particular in terms for example of the choice of surface regions of the metallic base body 23 of the component that are to be coated.

For a functional formation of a channel structure 13a of the anodic half-cell from a titanium base material, the gas diffusion layer 11a has for example typically been formed from a porous structure with a relatively large surface area, for example from a nonwoven, an expanded grid and/or layered from a plurality of gas diffusion plies or also combinations of these. For an effective corrosion protection, a porous structure of this kind with a large surface area of the gas diffusion layer 11a has then been provided on the surface, preferably over the whole area, with a closed protective layer of coating material 31 containing iridium and/or iridium carbide. The corrosion-resistant coating 29 has consequently also been applied to components or elements with very complex surface structures 29 in order to achieve maximally complete corrosion protection. This then also has an influence on the use of the coating process. The corrosion-resistant coating 31 has optionally been applied using physical thin-film technology methods, preferably coating methods such as physical vapor deposition (PVD) or plasma-assisted chemical vapor deposition. The corrosion-resistant coating 29 can be flexibly used for different components of an electrolysis cell 1, typically for nonwovens, bipolar plates or gas diffusion plies. Depending on the respective component, the layer thickness range is set to 0.02-0.5 micrometers, for example also between 0.08 to 0.3 micrometers, and can thus be chosen to be comparatively thin for the use case.

Various possibilities are thus provided in the context of the invention for the respective specific configuration of the corrosion-resistant coating 29, and therefore a multiplicity of coating systems can be realized within the context of the corrosion protection concept.

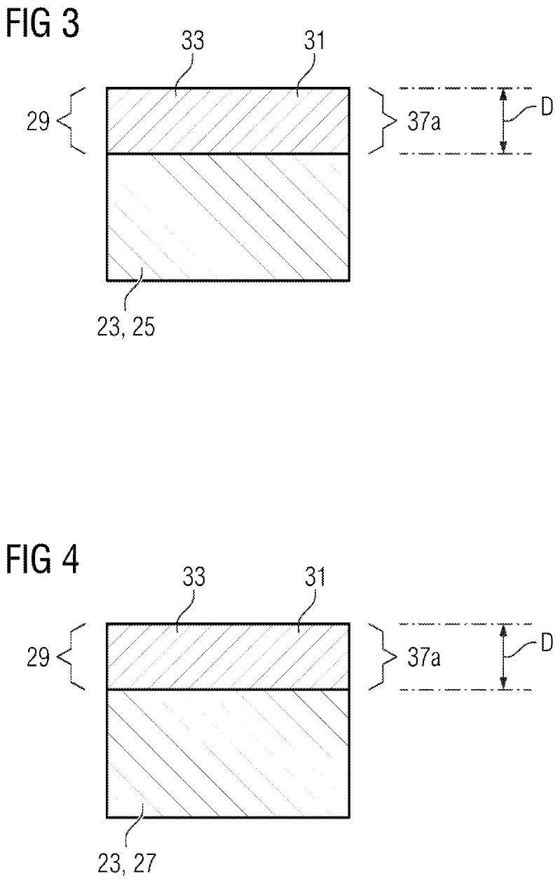

This is elucidated in more detail hereinafter with reference to the exemplary embodiments shown in FIG. 3 to FIG. 5. These exemplary embodiments share the common feature that the metallic base material 25, 27 used is titanium or stainless steel, as is typically provided for an anodic half-cell 7. The metallic base material 25 of the bipolar plate 21a is a stainless steel, for example of material number 1.4404 or 1.4571, and the metallic base material 27 of the gas diffusion layer 11b is titanium.

FIG. 3 shows a schematic illustration of a corrosion-resistant coating 29 in a configuration as homogeneous single-coat layer. The base body 23 forms the substrate made of a metallic base material 25, in this case a stainless steel. A corrosion-resistant coating 29 has been applied to the base body 23 in a single coat 37a—as a so-called monocoat—having a layer thickness D. The coating material 31 is present in a homogeneous mixed phase and as layer constituents includes iridium in a mixture with further constituents comprising titanium-niobium and titanium niobium nitride. The concentrations of the constituents in the homogeneous single-coat layer are approximately constant over the layer thickness D.

In contrast, FIG. 4 shows an alternative configuration of the corrosion-resistant coating 29 as graded single-coat layer. The graded single-coat layer has been applied as monocoat in a single coat 37a to the metallic base body 23 made of titanium 27 as substrate. The grading results in the concentration of the constituents of the layer material varying in a specific manner over the layer thickness D, forming a concentration gradient. In the present case, the concentration of iridium or optionally also iridium carbide in the coat 37a increases towards the surface. At the surface of the corrosion-resistant coating 29 the concentration of iridium or iridium carbide can be up to 100%, meaning that a closed protective layer of iridium or iridium carbide has been formed at the surface. The concentration of titanium-niobium and titanium niobium nitride correspondingly decreases towards the surface. The concentration of iridium or iridium carbide at the interface of the monocoat 37a with the substrate is vanishingly small or equal to zero.

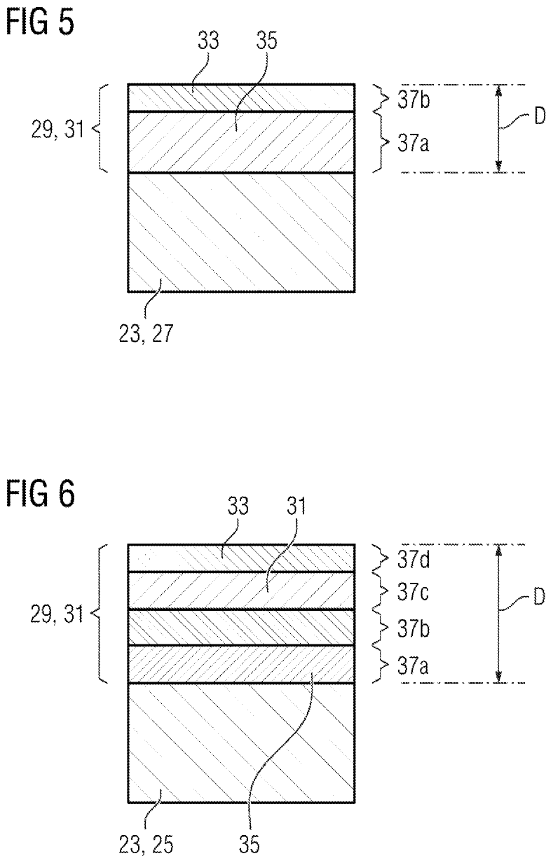

FIG. 5 shows a corrosion-resistant coating 29 that has been implemented as a multi-coat layer comprising two layered monocoats 37a, 37b. It has a first coat 37a which has been applied to the substrate and a second coat 37b, the second coat 37b having been applied to the first coat 37a. The substrate has been formed from a metallic base body 23 having a metallic base material 27, in the present case titanium. The second coat 37b forms the top layer 33 and thus the surface of the corrosion-resistant coating 29. The second coat 37b has been implemented as a thin homogeneous monocoat with iridium or iridium carbide as essential coating material 31. Admixtures of titanium-niobium and/or titanium niobium nitride are possible. The first coat 37a forms an intermediate layer 35 between the base body 23 made of titanium and the top layer 33. The intermediate layer 35 is adhesion promoting and ensures good adhesion and lasting attachment of the corrosion-resistant coating 29 to the base body 23, which is promoted by the binary and/or ternary titanium-based layer material 31 in the intermediate layer 35. It is also possible for both coats 37a, 37b or one of the coats 37a, 37b to each be implemented as graded monocoat in accordance with the exemplary embodiment in FIG. 4.

In FIG. 6, a corrosion-resistant coating 29 has been implemented as a complex multi-coat layer system. This layer system has been applied to the base body 23 made of a metallic base material 25, in the present case a stainless steel as substrate. The three stacked coats 37a, 37b, 37c form an intermediate layer 35 onto which the coat 37d has been applied as top layer 33. The coating is a graded multi-coat layer of layer thickness D, meaning that at least within the coats 37a, 37b, 37c forming the intermediate layer 35 the concentration of the constituents titanium-niobium, titanium niobium nitride and iridium and/or iridium carbide varies in the growth direction of the layers 37a to 37d and has been adjusted in a controlled manner with respect to the requirements for corrosion protection. The top layer 33 has been implemented as a homogeneous single-coat layer in the coat 37d with a high proportion of iridium and/or iridium carbide of up to 100%. However, it is also possible that the top layer 33 has been implemented as a graded single-coat layer, or that individual ones of the coats 37a, 37b, 37c of the intermediate layer 35 have been implemented as a homogeneous single-coat layer. During operation in an electrolysis cell 1, the top layer 33 is directly exposed via its surface to corrosive attack as a result of the high oxygen concentration in an anodic half-cell 7.

The corrosion-resistant coating 29 is particularly advantageously used for the coating of metallic components or functional parts of an electrolysis cell 1, preferably in the anodic half-cell 7. Provision is made particularly in an anodic half-cell 7 for the use of the corrosion-resistant coating 29 in a bipolar plate 21a or a gas diffusion layer 11a. In general, all components, elements or functional parts that form a channel structure 13a in the anodic half-cell 7 and the surfaces of which during operation are exposed to a harmful corrosive attack with oxygen can be considered for use of the corrosion-resistant coating 29.

It will be appreciated that other embodiments can be used and structural or logical modifications can be made without departing from the scope of protection of the present invention. Thus, features of the exemplary embodiments described herein can be combined with one another unless specifically stated otherwise. The description of the exemplary embodiments should accordingly not be interpreted in a limiting sense, and the scope of protection of the present invention is defined by the appended claims.

The expression “and/or” used herein means, when used in a series of two or more elements, that each of the elements stated can be used alone or any combination of two or more of the listed elements can be used.

1. An electrolysis cell for polymer electrolyte membrane electrolysis comprising a cathodic half-cell and an anodic half-cell, wherein the cathodic half-cell and the anodic half-cell are separated from one another by means of a polymer electrolyte membrane, at least one of the half-cells having
a channel structure formed of a gas diffusion layer and of a bipolar plate,
wherein the bipolar plate has a base body made of a metallic base material and to which a coating of a coating material has been applied, and
wherein the coating material is present in a homogeneous mixed phase comprising titanium-niobium (TiNb), titanium niobium nitride and also iridium and/or iridium carbide (IrC).

2. The electrolysis cell as claimed in claim 1, in which the coating has been applied as a homogeneous single-coat layer on the base body.

3. The electrolysis cell as claimed in claim 1, in which the coating includes titanium-niobium (TiNb) and titanium niobium nitride (TiNbN) as base constituents, to which iridium (Ir) and/or iridium carbide (IrC) has been admixed.

4. The electrolysis cell as claimed in claim 1, in which at least in a region of the channel structure the coating has been applied to the bipolar plate over the whole area in the form of a closed protective layer on the base body.

5. The electrolysis cell as claimed in claim 1, in which the base body of the bipolar plate has a multiplicity of grooves or channels, such that during operation fluid transport is promoted in the channel structure and a uniform electrical contacting and voltage supply of the half-cells can be brought about.

6. The electrolysis cell as claimed in claim 1, in which the coating is formed as a thin monocoat layer having a layer thickness (D) of 0.08 to 0.3 micrometers, in particular of around 0.02 to 0.5 micrometers.

7. The electrolysis cell as claimed in claim 1, in which the coating has been applied by means of physical vapor deposition (PVD) or plasma-assisted chemical vapor deposition (PACVD).

8. The electrolysis cell as claimed in claim 1, in which the metallic base material is stainless steel or titanium.

9. A method for application of a coating as protective layer to a metallic component of an electrolysis cell, including titanium-niobium (TiNb) and titanium niobium nitride (TiNbN) and alternatively either iridium carbide (IrC) or iridium (Ir), or iridium carbide (IrC) and iridium as a blend.

10. The method as claimed in claim 9, wherein the coating is a homogeneous single-coat layer applied on a metallic base material.

11. The method as claimed in claim 9, wherein the coating is disposed on a metallic component of an electrolysis cell.

12. The method as claimed in claim 11, wherein the metallic component is a bipolar plate forming a channel structure and/or a gas diffusion layer as metallic component of an electrolysis cell, in particular in an anodic half-cell of an electrolysis cell.
